(19) United States
(12) Patent Application Publication
(10) Pub. No.: US 2012/0114103 A1
(43) Pub. Date: May 10, 2012

(54) TRANSPORT BIN IDENTIFICATION

(76) Inventors: Stefan Aust, Idstein (DE); Harald Jentsch, Idstein (DE)

(21) Appl. No.: 13/251,882

(22) Filed: Oct. 3, 2011

Related U.S. Application Data
(63) Continuation of application No. PCT/EP2010/001341, filed on Mar. 4, 2010.

(30) Foreign Application Priority Data
Apr. 2, 2009 (DE) 10 2009 015 606.2

(51) Int. Cl. H05G 1/64; B65D 79/00

(52) U.S. Cl. 378/98.2; 206/216

(57) ABSTRACT

A transport bin in an X-ray inspection system is provided that includes an identification component securely connected to the bin and having a bin-specific identification.

This nonprovisional application is a continuation of International Application No. PCT/EP2010/001341, which was filed on Mar. 4, 2010, and which claims priority to German Patent Application No. DE 10 2009 015 606.2, which was filed in Germany on Apr. 2, 2009, and which are both herein incorporated by reference.

### BACKGROUND OF THE INVENTION

1. Field of the Invention

The present invention relates to a transport bin in an x-ray inspection system and to an x-ray inspection system.

2. Description of the Background Art

X-ray inspection systems are used, for example, to inspect the hand luggage of flight passengers for illegal or dangerous contents. To this end, at an initial inspection station with an x-ray unit an x-ray image is made of the luggage item to be inspected. Luggage items that cannot be clearly classified as unsuspicious based on the x-ray image are opened by another operator and inspected further. To this end, the operator at the secondary inspection station has a screen on which the previously produced x-ray image is shown. Because the initial inspection station with the x-ray unit and the secondary inspection station are usually separated spatially, the problem arises of identifying and displaying the x-ray image, associated with the luggage item to be inspected, rapidly and reliably at the secondary inspection station.

### SUMMARY OF THE INVENTION

In an embodiment, a transport bin of the invention has an identification device securely connected to the bin. The identification device contains a unique identifier of the transport bin. The identification device is, for example, an RFID transmitter, a barcode, or lead markers. An object to be inspected is placed in the transport bin, so that the identifier of the transport bin also clearly identifies the luggage item during the inspection process.

An x-ray inspection system of the invention includes inter alia of an initial inspection station, a secondary inspection station, and at least one transport bin. Each transport bin has a unique identifier. The initial inspection station has an x-ray unit for generating an x-ray image, device for reading the identification device of the transport bin, and device for assigning the x-ray image to the transport bin. The assignment of the x-ray image to the transport bin occurs via the identifier of the transport bin. The identifier of the transport bin is determined by reading the identification device.

The x-ray unit includes an x-ray device having at least one x-ray source and at least one x-ray detector in a radio-opaque housing and a control and display device. An x-ray image of the luggage item is computed from the output signal of the x-ray detector and displayed on the display device.

The device for reading the identification device of the transport bin can be, for example, an RFID receiver or a barcode reader. These devices are advantageously arranged in the vicinity of the x-ray device. Alternatively or in addition, the device for reading the identification device of the transport bin is an image processing routine, which extracts the identifier from the x-ray image.

The secondary inspection station can have a device for reading the identification device of the transport bin and a device for displaying the x-ray image assigned to the transport bin. The display device is preferably connected to the x-ray unit of the initial inspection station to be able to access the x-ray image to be shown from the said station.

The device for reading the identification device can be, for example, an RFID receiver or a barcode reader. Alternatively or in addition, the device for reading the identification device is an optical detection device such as a camera. The detection device recognizes either the lead markers directly or writing that contains the same identifier as the lead markers.

During the security inspection of an object, the object can be first placed in a transport bin. Then, an x-ray image of the object is taken and evaluated, for example, by an operator. Further, the identifier of the transport bin is read and automatically assigned to the associated x-ray image. Then, the transport bin is transported to a secondary inspection station, the identifier of the transport bin is determined, and the x-ray image assigned to transport bin identifier is displayed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an x-ray inspection system;

FIG. 2 shows a transport bin with an RFID transmitter;

FIG. 3 shows a transport bin with a barcode;

FIG. 4 shows a transport bin with lead markers; and

FIG. 5 shows an x-ray image when using a transport bin with lead markers.

### DETAILED DESCRIPTION

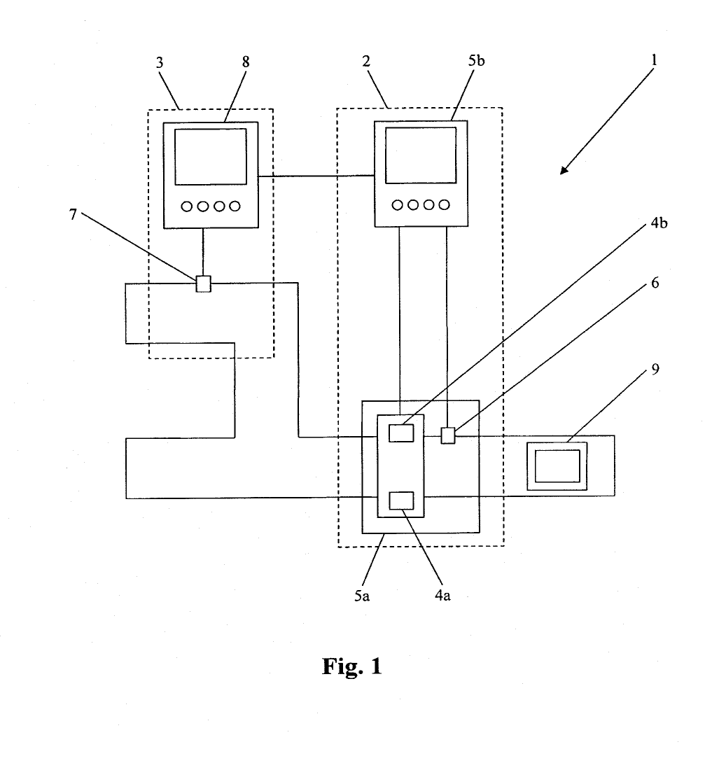

FIG. 1 shows schematically an x-ray inspection system 1 with an initial inspection station 2 and a secondary inspection station 3. Initial inspection station 2 comprises an x-ray unit 5 with an x-ray device 5a and a control and display device 5b, device 6 for reading identification device of a transport bin 9, and a device for assigning an x-ray image to transport bin 9. X-ray device 5a contains an x-ray source 4a and an x-ray detector 4b in a radio-opaque housing. Secondary inspection station 3 comprises a control and display apparatus 8 and a device 7 for reading the identification device of transport bin 9.

An object to be examined is placed in transport bin 9 and transported together with it through the x-ray device 5a. The object and transport bin 9 are exposed to x-radiation from x-ray source 4a. X-ray detector 4b passes the intensity of the transmitted x-radiation to the control and evaluation device 5b, which computes and displays an x-ray image therefrom. In addition, the identifier of transport bin 9 is determined by a device 6 and the x-ray image is assigned to the identifier.

If the object cannot be classified as unsuspicious by the operator of initial inspection station 2, transport bin 9 with the object is conveyed to secondary inspection station 3. There, the identifier of transport bin 9 is determined and the x-ray image assigned to the identifier, and thereby the object, is displayed on the control and display device 8.

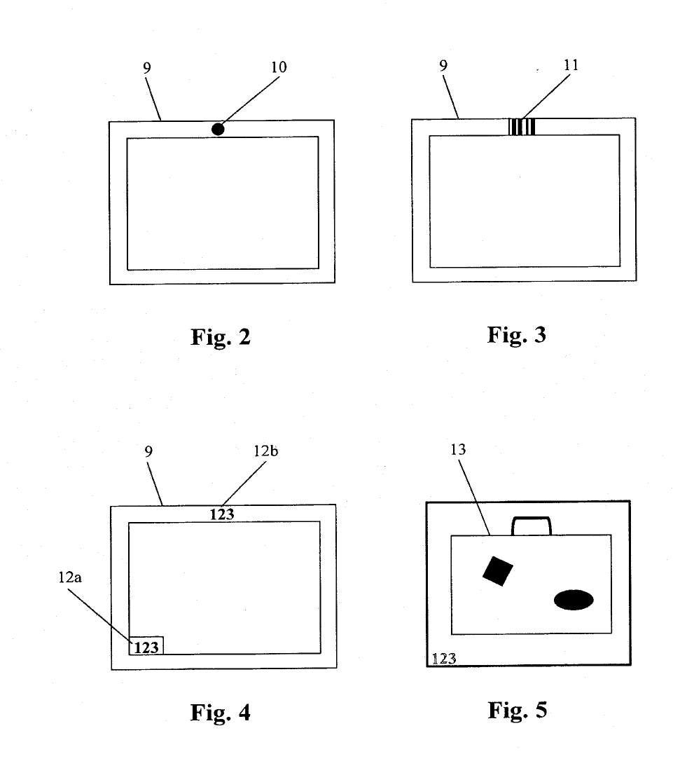

In a first exemplary embodiment according to FIG. 2, the identification device securely connected to transport bin 9 is an RFID transmitter 10. RFID transmitter 10 emits the identifier of transport bin 9 continuously or upon request. In this exemplary embodiment, the devices 6 and 7 for reading the identification device are formed as RFID receivers.

In a second exemplary embodiment according to FIG. 3, the identification device securely connected to the transport bin is a barcode 11. In this exemplary embodiment, the devices 6 and 7 for reading the identification device are barcode readers.

In a third exemplary embodiment according to FIG. 4, identification device 12 securely connected to the transport bin are lead markers 12a and writing 12b. Lead markers 12a, for example, are embedded into the material of transport bin 9. The x-radiation emitted by x-ray source 4a is attenuated by lead markers 12a, as a result of which lead markers 12a are recognizable in the x-ray image. The device 6 for reading the identification device of transport bin 9 in the present example, as a departure from the illustration in FIG. 1, is a component of the x-ray image-generating device of initial inspection station 2.

An exemplary x-ray image is shown in FIG. 4. Apart from the contour of object 13 to be examined, the contour of lead markers 12a is also recognizable in the x-ray image. Said contour corresponds to the identifier of transport bin 9 to which the x-ray image is assigned. Image processing software recognizes the contour of lead markers 12a and extracts therefrom the identifier of transport bin 9.

The identifier, moreover, is applied to transport bin 9 visually perceivable, for example, as writing 12b. Writing 12b is detected and recognized by the device 7, in the form of a video camera, for reading the identification device. Alternatively, the operator of secondary control station 3 enters the identifier manually in the control and display apparatus 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transport bin in an x-ray inspection system comprising:
an identification device connected securely to the transport bin; and
a bin-specific identifier associated with the identification device.

2. The transport bin according to claim 1, wherein the identification device is an RFID transmitter.

3. The transport bin according to claim 1, wherein the identification device is a barcode.

4. The transport bin according to claim 1, wherein the identification device is a lead marker.

5. An x-ray inspection system comprising:
at least one transport bin according to claim 1;
an initial inspection station having an x-ray unit for generating an x-ray image, a device for reading the identification device of the transport bin, and a device for assigning the x-ray image to the transport bin; and
a secondary inspection station having a device for reading the identification device of the transport bin and a device for displaying the x-ray image assigned to the transport bin.

6. A method for security inspection of an object and/or hand luggage, the method comprising:
Placing the object in a transport bin according to claim 1;
taking an x-ray image of the object;
evaluating the x-ray image;
determining an identifier of the transport bin;
automatically assigning the x-ray image to the transport bin;
transporting the transport bin to a secondary inspection station;
determining the identifier of the transport bin; and
displaying the x-ray image assigned to the transport bin.
